(19) United States
(12) Patent Application Publication
(10) Pub. No.: US 2017/0299886 A1
(43) Pub. Date: Oct. 19, 2017

(54) SYSTEMS, DEVICES, AND METHODS FOR PLACING FEATURES DIRECTLY ONTO THE RIMS OF SPECTACLE LENSES

(71) Applicant: VECTORIM LTD., Givat Ela (IL)

(72) Inventors: Yuval CARMON, Kiryat Tivon (IL); Tamir WEBMAN, Zikhron Yaakov (IL); Dan KATZMAN, Givat Ela (IL)

(73) Assignee: VECTORIM LTD., Givat Ela (IL)

(21) Appl. No.: 15/486,502

(22) Filed: Apr. 13, 2017

Related U.S. Application Data
(60) Provisional application No. 62/323,223, filed on Apr. 15, 2016.

(51) Int. Cl. G02C 7/02; B41J 2/14

(52) U.S. Cl. CPC G02C 7/021; B41J 2/1433

(57) ABSTRACT

Described herein are systems, devices, and methods to manufacture a feature onto the rim of an ophthalmic lens. In one embodiment, there are multiple lens rim features, and they are substantially restricted to the periphery of the lens. In alternative embodiments, the lens rim features are substantially restricted to either the top half or the bottom half of the periphery. In some embodiments, the features are added to a lens that has been finished for vision correction, whereas in other embodiments the features are added to a semi-finished lens. In one embodiment, there is a device for printing lens rim features onto an ophthalmic lens, and in another embodiment there is a system for printing such lens rim features. One embodiment is a method for printing a lens rim feature onto a lens, including the use of a device with a print-head and one or two grasping devices.

### BACKGROUND

In the ophthalmic industry, lenses and frames are produced in two separate processes and in two separate value chains.

Lenses are produced according to one of two methods. According to the first method, lenses are mass produced to a semi-finished state, stored in that state, and then later the back-surface curvature is processed according to the customer's specific prescription, taking into account the front surface curvature and the lens refraction index. This back-surface processing is called surfacing. A prescription may include a prescription for near vision and/or a prescription for far vision. Surfacing of back surface according to the customer's prescription is usually carried out at an optical lab. The back surface thus processed may be a simple toric surface, or a more complex freeform surface.

Alternatively, according to the second method, finished lenses having a finished prescription may be mass produced and held in stock until such a time that an order fitting that prescription is requested for a particular customer. At that time, the finished lens matching that prescription will be taken off the shelf and used. The majority of spectacle lenses produced today are produced in accordance with the second method.

Whether the lens is produced first to a semi-finished state or to a finished state, this lens may be stocked at the retail location or at the optical lab. There are many types of lenses currently used with spectacles for vision correction such as, for example, single vision lenses, progressive addition lenses or bifocal lenses.

Another type of lens commonly used in spectacles are lenses that have zero refractive properties altogether. These lenses are used by customers who do not require vision correction. They are used in many applications including protection from sun illumination, in protective eyewear, and for special color filters for specialized activities, such as target shooting for example. Such lenses are often referred to as “plano lenses”. They often have physical features that make them suitable for achieving their requirements—such as incorporation of linear polarizers for sun-wear lenses, or incorporation of high impact resistance materials for eyewear safety applications.

Frames are typically mass produced, with temples and a frame bridge. Frame rims are also a part of many frames and are used to attach the lens to the frame. A number of such frames are sent to the person providing the lenses, typically the optician at a retail location, who displays such frames as part of his inventory and who is limited in what he can offer to the size of this personal inventory. Such frames are not customized for a specific customer.

In the final stage, the lenses are edged to the desired outer contour shape and placed in the frame, either by an optician at the retail location or by optical lab personnel.

The current state of the art for supplying and manufacturing spectacles is very inefficient in the sense that retailers must stock a large inventory of frames, the distribution and manufacturing process is costly and time-consuming, and reduces the choice of spectacles available to customers. Further, the current systems, devices, and methods of offering features grant to customers only a limited choice of features, and allow them very little possibility of customizing the final product according to their personal taste.

### SUMMARY

Described herein are systems, devices, and methods for placing features directly onto the rims of spectacle lenses.

Presented are products, systems, and methods for producing customized features directly onto lenses, particularly onto a part of the lens which is called herein “the lens periphery”. These lens rim features may be added at the stage from raw material directly to finished product, or may be added to semi-finished lenses when they are mass produced, or may be added to lenses that have been finished for vision correction. In other embodiments, there is no vision correction, because customers wear spectacles as a fashion statement, or as sunglasses, or as some other kind of protective eyewear without vision correction. In those embodiments without vision correction, the various options of production remain but there is no stage from semi-finished without vision correction to finished spectacles with vision correction.

Among the benefits of various embodiments is the reduction in the variety of frames (since variety can now be provided by features on the lens rim of the spectacles rather than on the frame), reduced inventory at the place of production and/or at the place of providing the spectacles, enhanced speed of supplying spectacles to customers, and a significant increase in the nature and variety of customizable features that may be offered to customers.

One embodiment is an ophthalmic lens with a lens rim feature, including an ophthalmic lens with corrective optics, and one or more lens rim feature, in which the ophthalmic lens rim feature is an integral part of the ophthalmic lens. In alternative embodiments, the lens does not have vision corrective optics.

One embodiment is a semi-finished ophthalmic lens with a lens rim feature, including a semi-finished ophthalmic lens with a front surface having surface curvatures according to a specification, wherein the semi-finished ophthalmic lens is configured to receive back surface surfacing, and at least one lens rim feature, in which the lens rim feature is an integral part of said semi-finished ophthalmic lens.

One embodiment is a device for printing onto an ophthalmic lens, including an inkjet print-head configured to print a lens rim feature onto an ophthalmic lens, wherein the inkjet includes at least one nozzle, and each nozzle is configured to eject material onto an ophthalmic lens. Further, the device and the ophthalmic lens are configured to move and rotate their relative positions such that for every nozzle, the nozzle's axis and the ophthalmic lens are approximately perpendicular the one to the other in the printing area during the ejection of material by the nozzle onto the ophthalmic lens.

One embodiment is a system for printing a lens rim feature onto an ophthalmic lens, including an ophthalmic lens, a device with a print-head having at least one nozzle configured to create a lens rim feature by ejecting material through its nozzle onto said ophthalmic lens, a computer that is fitted with software capable of calculating at each instance the optimal position and orientation of said print head in relation to the ophthalmic lens, and that is capable of converting a graphical file that is to be printed into machine instruction that are communicated to the device with print head, a device for grasping the ophthalmic lens, and a device for moving and rotating either said ophthalmic lens or the device with print-head. Further, the moving and rotating device is configured to perform the rotation such that for every nozzle, the ophthalmic lens and the nozzle's axis of said device with print-head are approximately perpendicular the one to the other in the printing area during the ejection of material from said print-head onto said ophthalmic lens.

One embodiment is a method for manufacturing an ophthalmic lens with a lens rim feature. A device with a print-head having at least one nozzle for ejecting material is programmed to create a lens rim feature by ejecting such material onto an ophthalmic lens. A grasping device grasps the ophthalmic lens. A grasping device grasps the programmed device with print-head. In some embodiments, a single grasping device grasps the ophthalmic lens and the programmed device with print-head, but in alternative embodiments different grasping devices grasp the ophthalmic lens and the programmed device with print-head, respectively. The single grasping device, or alternative one or both grasping devices if there are two such devices in an embodiment, adjusts the relative position and orientation of the ophthalmic lens or the programmed device with print-head such that the ophthalmic lens and nozzle's axis of said programmed device with print-head are approximately perpendicular the one to the other in the printed area during the ejection of material from the device with print-head onto the printed area of such ophthalmic lens

One embodiment is a method for manufacturing an ophthalmic lens with a lens rim feature. A layer of paint capable of adhering to a surface of an ophthalmic lens is applied onto a roller or other rolling device. A grasping device grasps the ophthalmic lens. A grasping device grasps the roller or other rolling device with the layer of paint, wherein said grasping device may be the same device that grasps the ophthalmic lens, or may be a second grasping device. The grasping device(s) move and rotate the ophthalmic lens and the roller or other rolling device the one in relation to the other, such that the roller comes into contact with the lens at one or more predesignated locations on the appropriate lens surface. The grasping device(s) then rolls the roller upon the lens at such locations, and such rolling creates lens rim features on said locations. In alternative embodiments, there are two more acts of rolling, and such acts may occur on any part of the lens, including the front surface, the back surface, or the edged lens face. In alternative embodiments, the grasping may be done by human hands.

One embodiment is a method for manufacturing an ophthalmic lens with a lens rim feature. A grasping device grasps the ophthalmic lens. A grasping device grasps a laser capable of creating abrasions on the lens surface, wherein said grasping device may be the same device that grasps the ophthalmic lens, or may be a second grasping device. The grasping device(s) move and rotate the ophthalmic lens and the laser the one in relation to the other, such that they are positioned so that one or more lens features may be created by the laser onto predesignated locations on the lens surface. Laser pulses are applied from the laser onto the lens surface. The grasping device(s) move and rotate the ophthalmic lens and the laser the one in relation to the other while the laser pulses are being applied, such the shapes or one or more lens features are applied onto the predesignated locations of the appropriate lens surface.

One embodiment is a method for manufacturing an ophthalmic lens with a lens rim feature. A grasping device grasps an ophthalmic lens. A grasping device grasps a machining tool capable of making cuts in the lens, wherein said grasping device may be the same device that grasps the ophthalmic lens, or may be a second grasping device. The grasping device(s) use a CNC controller to move and rotate the ophthalmic lens and the machining tool the one in relation to the other, such that they are positioned so that one or more lens features may be created by the machining tool onto predesignated locations on the lens surface. The grasping device(s) move and rotate the ophthalmic lens and the machining tool one or more times, such that the shapes of the lens features have been applied at the predesignated locations on the appropriate lens surface.

One embodiment is a method for manufacturing an ophthalmic lens with a lens rim feature. One or more lens rim features are applied to an adhesive sticker at places on the sticker that will later be applied to predesignated locations on a lens surface. A grasping device grasps an ophthalmic lens. A grasping device grasps the adhesive sticker. The grasping device(s) move and rotate the ophthalmic lens and the adhesive sticker the one in relation to the other, such that they are positioned so that one or more lens rim features may be created by adhering parts of the adhesive sticker onto predesignated locations on the appropriate lens surface. Contact is created between the adhesive sticker and the lens surface such that the lens rim features are adhered to the lens surface. In some embodiments, the sticker along with the lens rim features applied to it is adhered permanently to the appropriate lens surface. In alternative embodiments, the grasping may be done by human hands.

One embodiment is a method for manufacturing an ophthalmic lens with a lens rim feature, by one or a combination of specific techniques. Material is selected to create a mask. The material is then cut to a shape that a mask is created that may be placed on an ophthalmic lens. Cuts are made in the mask in the shapes, and at predesignated locations on the mask, such that the cuts will leave openings at predesignated locations on the lens for rim features. A grasping device grasps the ophthalmic lens. A grasping device grasps the mask. The grasping device(s) move and rotate the ophthalmic lens and the mask the one in relation to the other, such that they are positioned so that the cuts in the mask are over the predesignated locations on the appropriate lens surface for lens rim features. The mask is placed in physical contact with the appropriate lens surface, such that the cuts are explicitly on the predesignated locations for lens rim features. A specific technique is applied to create the lens rim features on the appropriate lens surface at the predesignated locations. The lens and the mask are then separated. Among the specific techniques that may be applied are painting, sand blasting, chemical abrasion, or some combination of such techniques. In alternative embodiments, the grasping may be done by human hands.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1A illustrates one embodiment of a frontal view of an ophthalmic lens with a lens rim feature.

FIG. 1B illustrates one embodiment of a side view of an ophthalmic lens.

FIG. 1C illustrates one embodiment of a frontal view of an ophthalmic lens with a lens rim feature.

FIG. 2A illustrates one embodiment of a frontal view of a semi-finished ophthalmic lens with a lens rim feature.

FIG. 2B illustrates one embodiment of a side view of a semi-finished ophthalmic lens.

FIG. 2C illustrates one embodiment of a frontal view of a semi-finished ophthalmic lens with a lens rim feature.

FIG. 3 illustrates one embodiment of a device for printing onto an ophthalmic lens.

FIG. 4 illustrates one embodiment of a system for printing onto an ophthalmic lens.

FIG. 5 illustrates one embodiment of a nozzle in relationship to an ophthalmic lens.

FIG. 6 illustrates one embodiment of a method for manufacturing one or more lens rim features onto an ophthalmic lens by use of a programmed device with print head.

FIG. 7 illustrates one embodiment of a method for manufacturing one or more lens rim features onto an ophthalmic lens, by applying a layer of paint using a roller or rolling device.

FIG. 8 illustrates one embodiment of a method for manfacturing one or more lens rim features onto an ophthalmic lens, by use of a laser.

FIG. 9 illustrates one embodiment of a method for manufacturing one or more lens rim features onto an ophthalmic lens, by use of a machining tool.

FIG. 10 illustrates one embodiment of a method for manufacturing one or more lens rim features onto an ophthalmic lens, by use of an adhesive sticker.

FIG. 11 illustrates one embodiment of a method for manufacturing an ophthalmic lens with a lens rim feature, by one or a combination of specific techniques.

### DETAILED DESCRIPTION

Described herein are systems and methods to adapt incoming streams of data for distributed processing.

Herein, the following terms shall have the meanings indicated.

“Finished lens” is a lens suitable for use as a vision corrector, in which both the front surface and back surface have appropriate curvatures taking into account the index of refraction of the lens, such that the spectacles will correct vision for a specific customer, but prior to the introduction of lens rim features. Some embodiments involve spectacle lenses with no refractive properties, such as, for example, decorative glasses, sun glasses, and other protective glasses; such embodiments also including a “finished lens”, but in these cases the lens does not serve any vision correction role.

“Semi-finished lens” is a lens not yet suitable for use as a vision corrector, in which the front surface has a specified curvature or set of different curvatures at different locations, but prior to surfacing of the back surface of the lens and prior to the introduction of lens rim features.

“Periphery of a lens” is a part of the front surface and/or back surface of a lens that is some measure from the edge of the lens inward toward the center of lens, but that constitutes less than the entire surface of the lens. The periphery may also include the edged lens face. If a lens were divided with a horizontal line into two approximately equal halves, the “top part of the periphery” is the part of the periphery above the horizontal line and the “bottom part of the periphery” is the part of the periphery that is below the horizontal line. For example, the “periphery” might be defined as the region from the edge of the lens 5 mm toward the center on the front surface and 5 mm toward the center on the back surface, all the way around the edge. In this example, the “top part of the periphery” would be the part of the “periphery” located within the top hemisphere of the front surface and back surface of the lens. Or as another example, the “periphery” might be defined as the region from the edge toward the center of the back surface and from the edge towards the center of the front surface where the periphery has a constant width, such that the “periphery's” area on the back surface constitutes 25% of the back surface area, and the “periphery's” area on the front surface constitutes 25% of the front surface area. In this example, the “bottom part of the periphery” would be that part of the “periphery” located within the bottom hemisphere of the back and front surface of the lens. As another example, the “periphery” might be defined as the region from the edge of the lens 3 mm, 4 mm or 10 mm toward the center on the front surface and 3 mm or 4 mm or 7 mm toward the center on the back surface, all the way around the edge, and also including the edged lens face. The “periphery” may be only on the front surface, or only on the back surface, or on both the front and back surfaces, all in accordance with the various embodiments.

“Feature” is some aspect that is printed or otherwise manufactured on any surface of the lens. It may be a shape, it may be a color or multiple colors, it may be a certain surface, it may be a machined feature, it may be a particular aspect or function, or it may be any combination of the foregoing. For example, a relatively simple feature might be one or a series of small red-colored triangles. For example, a more complicated feature may be a variety of shapes in different colors, any treated with Day-Glo® or other special treatment such that the feature glows in the dark. For example, an even more complicated feature may be a unit that is configured to create a holographic image on the lens surface. Any item that may be printed, machined, applied using additive or subtractive manufacturing, printed onto an adhesive sticker and then glued to a lens, or otherwise manufactured onto the lens or machined out of the lens substrate; and that may give the lens beauty or functionality or affect its appearance, may be a feature.

“Lens rim feature” is a feature that is printed or otherwise manufactured on any surface of the lens, wherein the feature resides totally or substantially within the periphery of the lens.

“Integral part” integral means that a lens rim feature is a part of an ophthalmic lens, and can be viewed on the lens regardless of whether the lens is connected to a temple and or a nose piece. The lens and the lens rim feature may be made of the same material or different materials. The lens rim feature may be a fixed feature or may be removable. If removable, it may be removed by erasing or by mechanical dissolution or by chemical dissolution of a feature that is printed on. Alternatively, the lens rims feature may be manufactured to a sticker which is then attached to the lens, and the sticker may then be removed. “Integral part” does not include features that are hanging from the lens or from the spectacle frame.

“Appropriate lens surface” means the back surface, or the front surface, or the edged lens face, or two or three of these, as the case may be. Where no limitation is stated or implied, it is understood that “appropriate lens surface” may include any one or any two or all three of the surfaces may be “appropriate” in the particular case described.

When discussing manufacturing of a lens rim feature using inkjet printing, at each step of the printing process, the print-head covers an area of the lens over which a lens rim feature is to be printed. Each of the nozzles in the print head has a predesignated, relatively small subarea on the surface of the lens onto which it may eject material during this step. The multiple nozzle outlets are contained within a plane and the inkjets that they eject are perpendicular to this plane. The axis at the center of the nozzle is called the nozzle axis. Some of the embodiments herein describe methods in which for each nozzle in the print head, the plane defined by the nozzle outlet and the respective subareas on the lens, onto which the nozzles may eject material during the printing step, are approximately parallel. This is equivalent to saying that for each nozzle, the nozzle axis is approximately perpendicular to the predesignated lens subarea. One example of approximate perpendicularity is a maximum discrepancy from perpendicularity of five degrees for all nozzles during a single printing step. Another example is a maximum discrepancy of ten degrees. Another example is a maximum discrepancy of twenty degrees. At each printing step, the nozzle and its appropriate lens subarea should be relatively close. In one example, the nozzles and lens subareas should be no further than 3 mm for any nozzle. In another they should be no further than 2 mm for any nozzle. In another they should be no further than 1 mm.

There are at least two ways in which a device with multiple nozzles may nevertheless operate such that all of nozzles ejecting material do so when such nozzles are substantially perpendicular to the lens surface. In one way, the total area covered by the nozzles as a group during each printing step is relatively small, so that minor deviations in curvature of the lens do not change the fact that each nozzle is substantially perpendicular to the lens at the time the nozzles eject material. In the second way, at the time of ejection only the nozzles that are substantially perpendicular to the lens at the time of ejection may actually eject material onto the lens—the other nozzles will not eject material until they are substantially perpendicular to the surface of the lens.

Described herein are various embodiments to print or otherwise manufacture lens rim features directly onto an ophthalmic lens, optionally onto the periphery of the lens, which may be the entire periphery or a portion of the periphery, or only the top part of the periphery, or only the bottom part of the periphery, or either side of the periphery. In some embodiments, one or more lens rim features are printed or manufactured onto a finished lens. In other embodiments, one or more features are printed or manufactured onto a semi-finished lens, in which the lens may first be finished by surfacing of the back surface followed by addition of the features, or the features may be added first to the front surface and the back surface may then be surfaced, or the surfacing of the back surface and the addition of lens rim features occur substantially simultaneously. In another embodiment, after the lens has been edged, lens rim features may be added to the edged lens face. Other embodiments include a device for printing lens rim features onto an ophthalmic lens, and a system using such a device with other components to print the lens rim features onto an ophthalmic lens. Other embodiments include methods for printing lens rim features onto a lens, which may be restricted solely to the printing of the features, or which may combine printing of the features with finishing of the lens by adding a vision corrective surfacing process to the back surface of the lens. In alternative embodiments, the lens does not have vision corrective optics.

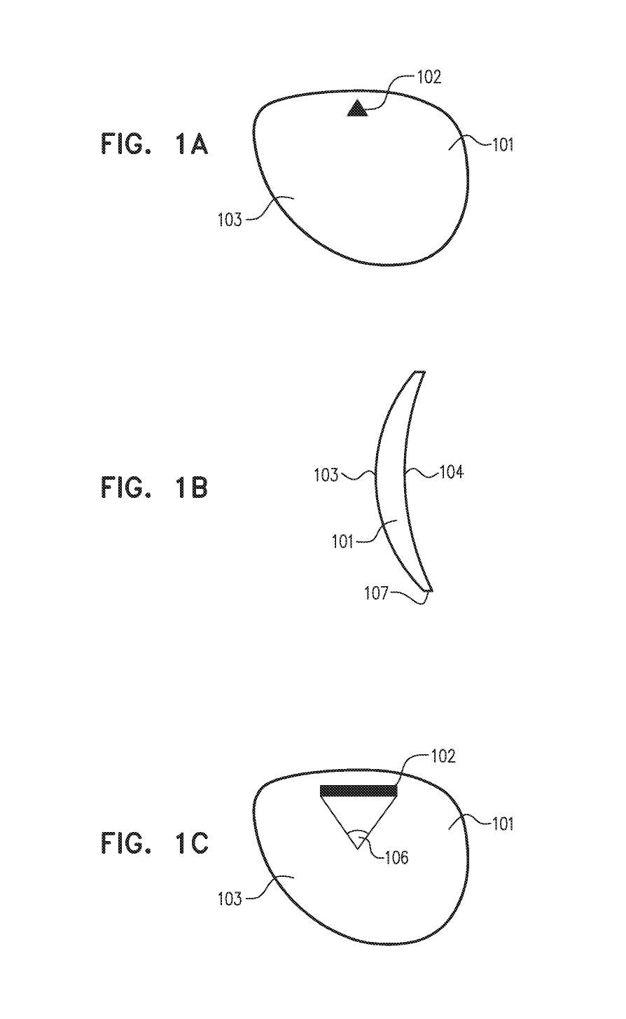

FIG. 1A illustrates one embodiment of a frontal view of an ophthalmic lens 101 with a lens rim feature 102. The lens 101 is shown with a front surface 103 which has been configured with curvatures for vision. A lens rim feature 102 is shown within the top part of the periphery of the lens, in which the particular rim feature illustrated, in a non-limiting example, is a small triangle. The front surface 103 may be surfaced for corrective vision, after which the lens rim feature 102 is added. Alternatively, the front surface 103 may be surfaced substantially simultaneously with the addition of the lens rim feature 102. In alternative embodiments, the lens does not have vision corrective optics.

FIG. 1B illustrates one embodiment of a side view of a finished ophthalmic lens 101. In this illustrative embodiment, the front lens surface has been configured 103 for corrective vision. Similarly, the back surface 104 has been surfaced for corrective vision, such that the combination of the curvature of the front surface 103 and of the back surface 104 taking into account the index of refraction of the lens, complete the changes to the lens 101 for corrective vision. After the front surface 105 and the back surface 104 have been processed to have the desired geometry and edged according to the frame shape, there is a resulting edged lens face 107. The lens rim feature that is to be applied on a front surface 105 or back surface 104 should be added after processing of the appropriate surface had taken place, but surfacing and application of lens rim feature may be done almost simultaneously. Operationally, therefore, the two processes can effectively form a single manufacturing step. In alternative embodiments, the lens does not have vision corrective optics. In one particular example of the embodiment, the back surface 104 and the front surface 103 are chosen specifically so that the refractive powers of the lens will be zero. In this case, the lens does not serve the purpose of vision correction, but may serve other purposes such as protection from sun illumination, cosmetic purposes, or protection from chemicals for example.

FIG. 1C illustrates one embodiment of a frontal view of an ophthalmic lens 101 with a lens rim feature 102, in which there is an angle of coverage 106, and in which the lens rim feature 102 is on the front of the lens 103 entirely or substantially within the periphery of the lens 101, thereby creating an angle of coverage 106 in relation to the lens center.

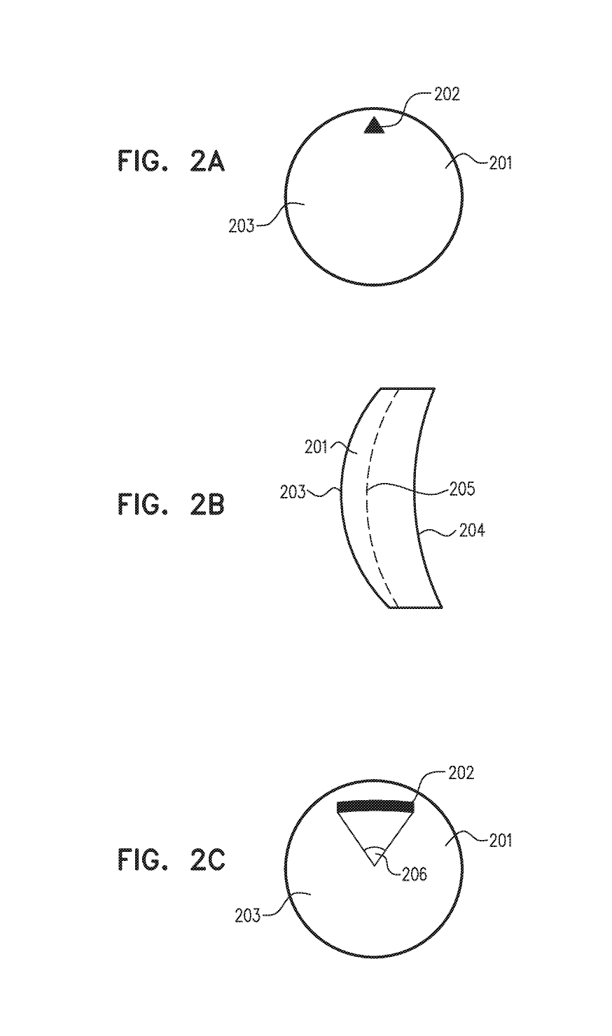

FIG. 2A illustrates one embodiment of a frontal view of a semi-finished ophthalmic lens 201 with a lens rim feature 202 located all or substantially all within the periphery of the lens 201. In FIG. 2A, the lens 201 has not yet been edged to the desired outer contour shape.

FIG. 2B illustrates one embodiment of a side view of a semi-finished ophthalmic lens 201. In this illustrative embodiment the front lens surface 203 has been configured with curvatures for corrective vision. The back surface 204 has not yet been surfaced for corrective vision, so that the lens 201 is only semi-finished. After surfacing of the back surface, it will appear substantially in the shape shown in the line 205, at which time the lens will become finished. In some embodiments, a lens rim feature 202 may be added prior to the surfacing of the back surface 204. In one embodiment, the front surface 203 is processed prior to the addition of a lens rim feature 202. In an alternative embodiment, the front surface 203 is processed substantially simultaneously with the addition of the lens rim feature 202.

FIG. 2C illustrates one embodiment of a frontal view of a semi-finished ophthalmic lens 201 with a lens rim feature, in which there is an angle of coverage 206, and in which the lens rim feature 202 is on the front 203 of the lens entirely or substantially within the periphery of the semi-finished lens 201, thereby creating an angle of coverage 206 in relation to the lens center. In FIG. 2C, the lens 201 has not yet been edged to the desired outer contour shape.

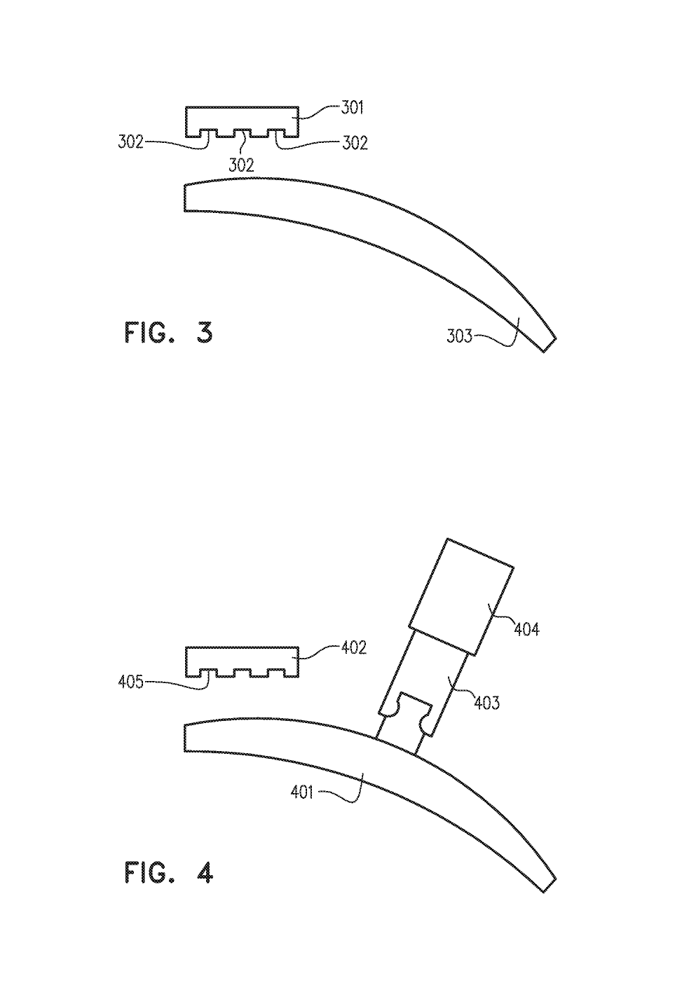

FIG. 3 illustrates one embodiment of a device for printing onto an ophthalmic lens. The device includes an inkjet print-head 301, which has at least one nozzle 302 for ejecting printing material onto a lens 303. The print-head 301 on the device, and the lens, 303, are configured to move and rotate their relative positions such that at the time any of the nozzles 302 ejects printing material onto the lens 303, the axis of the nozzle 302 and the lens 303 are approximately perpendicular the one to the other in the printing area. That is true even though the overall surface of the lens 303 is curved. At the relatively small area that is printed in each step, the axis of any of the nozzles 302 and the respective lens subareas for printing are approximately perpendicular. After that specific area is completed, the relative positions of the nozzles 302 and the lens 303 are adjusted for the ejection of material onto the next printing area. In various embodiments, the print-head 301 and the nozzles 302 are fixed in position, but the lens 303 moves. In some embodiments, the lens 303 is held fixed, while the print-head 301 with nozzles 302 changes its position. In some embodiments, both the print-head 301 with nozzles 302 and the lens 303 change their positions such that when the printing commences in the next subarea, the axis of each of the nozzles will be approximately perpendicular to the lens in the said next subarea.

FIG. 4 illustrates one embodiment of a system for printing onto an ophthalmic lens. The system includes an ophthalmic lens 401, a device with a print-head 402 with at least one nozzle 405, a grasping mechanism 403, a device 404 for moving and or rotating either or both of the ophthalmic lens 403 and the device with print-head 402, such that at the time the print-head 402 ejects material through nozzle 405 onto the lens 401, the lens 401 and the axis of each nozzle 405 is substantially perpendicular the one to the other at the area of printing. FIG. 4 shows an exemplary embodiment where the grasping mechanism 403 grasps the lens 401, and the rotating device 404 is attached to and behind the grasping mechanism 403. This is only one of many possible embodiments. In one alternative embodiment, there are two grasping mechanisms, one for the lens 401, and one for the print-head 402 with nozzle. In such case, either of the lens 401 or the print-head 402 may be in a fixed position, while the other element moves its position such that the axis of each nozzle 405 and the lens 401 are always approximately perpendicular at any point of ejection of material from the print-head 402 nozzle 405 onto the lens 401. An element that is held in a fixed position constantly must be grasped, but need not be moved and rotated. Alternatively, in some embodiments both the lens 401 and the print-head 402 are moved, whether with one grasping device or two grasping devices, such that the lens and the axis of each nozzle 405 is substantially perpendicular at every printing area, whenever the 405 ejects material onto the lens 401. In addition, in alternative embodiments there is a computer, with software, that is capable and configured to calculate at all times the optimal position and orientation of the print head in relation to the ophthalmic lens, and also to convert a graphical file which includes the features that are to be printed onto the lens, that may be converted into machine instructions that are communicated to the device with print head.

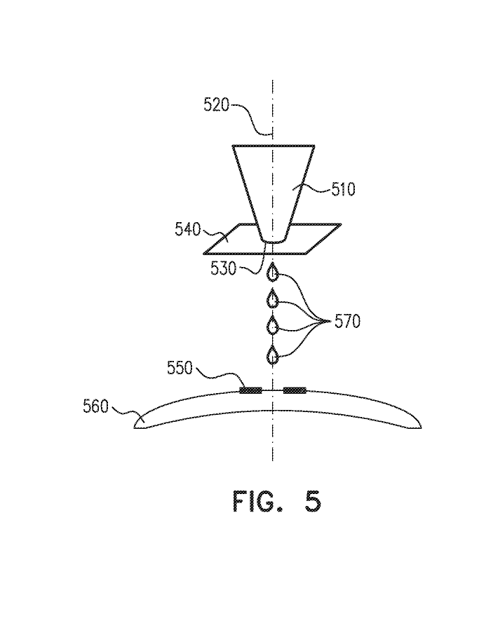

FIG. 5 illustrates one embodiment of a nozzle in relationship to an ophthalmic lens, in which there is a cross section view of a nozzle 510. In this illustrative embodiment, the nozzle axis 520 is the nozzle's axis of rotation. The nozzle outlet 530 is the closest element of the nozzle to the ophthalmic lens 560. The nozzle outlet 630 defines a plane 540. The lens 560 on which a lens rim feature is to be printed includes a subarea 550. The ejected material 570 (in one embodiment, they are inkjets) exits from the nozzle outlet 530, in the direction of the lens subarea 550.The nozzle axis 520 is approximately perpendicular to the nozzle outlet plane 530. It is also approximately perpendicular to the lens subarea 550. The nozzle outlet plane 540 is approximately parallel to the lens subarea 550.

One embodiment is an ophthalmic lens 101 with a lens rim feature 102, including an ophthalmic lens with corrective optics 101, and at least one lens rim feature 102, in which the ophthalmic lens rim feature 102 is an integral part of the ophthalmic lens 101. Although not illustrated in FIG. 1, FIG. 1 contemplates also embodiments in which there are multiple lens rim features rather than a single lens rim feature 102. In alternative embodiments, the lens does not have vision corrective optics.

In a first possible alternative to the ophthalmic lens 101 with a lens rim feature 102 just described, the ophthalmic lens 101 includes multiple lens rim features.

In a second possible alternative to the ophthalmic lens 101 described above with one or more lens rim features 102, further at least one lens rim features is custom designed in accordance with requirements of a particular order. (An “order” may be a prescription by a particular client/customer, or may be a request to inventory by an optician, or may be any other command or request to produce a lens with the particular lens rim feature.)

In a third possible alternative to the ophthalmic lens 101 with one or more lens rim features 102 described above, further the lens rim features are substantially restricted to the periphery of the lens.

In a possible configuration of the third possible alternative just described, further “substantially restricted” means that the lens rim features are manufactured onto the periphery of the lens, and means further that any part of the lens rim features that extend beyond the periphery of the lens do not occupy more than 25% of the area of lens. In other embodiments they do not occupy more than 15% or no more than 5% of the area of the lens, respectively.

In a first variation of the possible configuration just described, further the lens rim features do not extend substantially beyond the top part of the lens periphery.

In a second variation of the possible configuration just described, further the lens rim features do not extend substantially beyond the bottom part of the lens periphery.

In a fourth possible alternative to the ophthalmic lens 101 with one or more lens rim features 102 described above, further the lens rim features substantially occupy the area of the one half of the periphery of the lens.

In a possible configuration of the fourth possible alternative just described, further “substantially occupy one half” means that at least 90% of the area of that half of the periphery is occupied by the lens rim features. In other embodiment at least 80% or at least 70% of the area of the half of the periphery is occupied by lens rim features. In a first variation of the possible configuration just described, further the one half of the periphery that is occupied by lens rim features is the upper half.

In a second variation of the possible configuration just described above, further the one half of the periphery that is occupied by the lens rim features is the bottom half.

In a fifth possible alternative to the ophthalmic lens 101 with one or more lens rim features 102 described above, further the lens rim features within the one half of the periphery form a cumulative angle of coverage in relation to the center of the lens when the lens is viewed from the front, which is as large as or almost as large as the angle of coverage of one half of the periphery. The “cumulative angle of coverage” is the total of angle measurements, from the center of the lens to the periphery, which is created by all of multiple rim features within the one half of the periphery. The one half of the periphery can be the top half, the bottom half, or any other half of the periphery that has an angle of coverage of 180 degrees in relation to the center of the lens when viewed from a frontal direction. If a lens rim feature only partially resides within the one half of the periphery, we refer in this embodiment only to the part of it that is contained within the said one half. For example, if two lens rim features are within the one half of the lens periphery, if one feature has an angle of coverage of 45 degrees, and a second feature has an angle of coverage of 22 degrees, where the rim features do not overlap at all, then the cumulative coverage is 67 degrees, whether or not the two features are contiguous. Alternatively, if there are two features from within the one half of the periphery and they overlap in whole or in part, the overlapped portion is not counted twice to determine the cumulative angle of coverage. In the same example, one feature has an angle of coverage of 45 degrees, the second feature has an angle of coverage of 22 degrees, but the two features overlap by 10 degrees, then the total angle of coverage would be (45+22−10)=57 degrees. Hence, to say that the cumulative angle of coverage must be “almost as large” as the angle of coverage of one half of the periphery” is to say that the cumulative angle of coverage must be almost as large as 180 degrees. In one embodiment, “almost as large as 180 degrees” is an angle of at least 140 degrees. In other embodiments, “almost as large as 180 degrees” is an angle of coverage of at least 150, at least 160, or at least 170 degrees, respectively.

In a sixth possible alternative to the ophthalmic lens 101 with one or more lens rim features 102 described above, further at least one lens feature is on a surface of the lens selected from the group consisting of the front surface of the lens, the back surface of the lens, and the edged surface of the lens.

In a first possible configuration of the sixth possible alternative just described, the lens has a lens rim feature on the front surface of the lens.

In a second possible configuration of the sixth possible alternative just described, the lens has a lens rim feature on the back surface of the lens.

In a first configuration of the sixth possible alternative just described, the lens has a lens rim feature on the edged lens face of the lens.

In a seventh possible alternative to the ophthalmic lens 101 with one or more lens rim features 102 described above, further there are multiple lens rim features and at least two of the lens rim features are disconnected one from the other. In this sense, “disconnected” means that these two rim features are not contiguous and do not overlap when the lens is viewed from a frontal direction.

In an eighth possible alternative to the ophthalmic lens 101 with one or more lens rim features 102 described above, further at least one lens rim feature is substantially narrow when viewed from a frontal direction. In some embodiments, “substantially narrow” means less than one millimeter in width when viewed from a frontal direction, while in other embodiments it may be less than 1.5 mm, less than 0.5 mm, or less than 0.25 mm, respectively

In a ninth possible alternative to the ophthalmic lens 101 with one or more lens rim features 102 described above, further at least one lens rim feature is unconnected to the edged lens face. In this sense, “unconnected” means that the rim feature is not on the edged lens face in whole or in part, and is not contiguous to the edged lens face.

In a tenth possible alternative to the ophthalmic lens 101 with one or more lens rim features 102 described above, further at least one lens rim feature is substantially thin when the lens is viewed from the side. In some embodiments, “substantially thin” means that the lens rim feature protrudes less than 50 micrometers from the surface on which the feature resides. In other embodiments, the rim feature protrudes less than 5 microns, or less than 10 microns, or less than 20 microns, respectively.

In an eleventh possible alternative to the ophthalmic lens 101 with one or more lens rim features 102 described above, further the cumulative weight of all the lens rim features is substantially small. In some embodiments, “substantially small” means less than 0.1 gram. In other embodiments, substantially small weight is less than 0.5 gram or less than 1 gram, respectively.

In a twelfth possible alternative to the ophthalmic lens 101 with one or more lens rim features 102 described above, further at least one lens rim feature is substantially thick when the lens is viewed from the side. In some embodiments, “substantially thick” means that the lens rim feature protrudes at least 100 micrometers from the surface on which the feature resides. In other embodiments, substantially thick means that the lens rim feature protrudes by at least 500 microns, or at least 1000 microns, or at least 3000 microns, respectively.

In a thirteenth possible alternative to the ophthalmic lens 101 with one or more lens rim features 102 described above, further at least one lens rim feature is composed of the lens substrate material and has a surface roughness which is substantially higher than can be used for imaging optics.

In a fourteenth possible alternative to the ophthalmic lens 101 with one or more lens rim features 102 described above, further at least one lens rim feature is created by using CNC machine methods to remove lens substrate from the appropriate surface at the appropriate location on the lens. Examples of such CNC machine methods include machine milling, machine grinding, drilling, and machine turning, although any such methods are within the contemplation and scope of the embodiments described herein.

In a fifteenth possible alternative to the ophthalmic lens 101 with one or more lens rim features 102 described above, further the ophthalmic lens is attached to a rimless frame.

In a sixteenth possible alternative to the ophthalmic lens 101 with one or more lens rim features 102 described above, further the ophthalmic lens is attached to a frame that is a half rimless frame.

In a seventh possible alternative to the ophthalmic lens 101 with one or more lens rim features 102 described above, further the ophthalmic lens is attached to a frame that is a full frame

In an eighteenth possible alternative to the ophthalmic lens 101 with one or more lens rim features 102 described above, further at least one lens feature is located between a hard coating layer and the lens surface. In this embodiment, rim features on the front surface of the lens, or on the back surface of the lens, or on both front surface and back surface of the lens are envisioned.

In a nineteenth possible alternative to the ophthalmic lens 101 with one or more lens rim features 102 described above, further at least one lens feature is located on the back surface of the lens wherein both hard coating and anti-reflective coatings are applied to the front surface, but neither hard coating nor anti-reflective coatings are applied to the back surface of the lens.

In a twentieth possible alternative to the ophthalmic lens 101 with one or more lens rim features 102 described above, further at least one lens feature is located between a mirror coating and the wearer's eye when viewed by an external observer while the customer is wearing the spectacles. In this case, the mirror coating is envisioned to be on the front surface of the lens, while the lens rim feature is envisioned to be either on the front surface or the back surface of the lens. In a twenty-first possible alternative to the ophthalmic lens 101 with one or more lens rim features 102 described above, further at least one lens feature is on the back surface of the lens, and in addition the lens is tinted for sun wear.

One embodiment is a semi-finished ophthalmic lens 201 with one or more lens rim features 202, including a semi-finished ophthalmic lens 201 with a front surface 203 having surface curvatures according to a specification, in which the semi-finished ophthalmic lens 201 is configured to receive surfacing on its back surface 204, the lens front surface has one or more lens rim features, and the lens rim features 202 are an integral part of said semi-finished ophthalmic lens 201.

In a first possible alternative to the semi-finished ophthalmic lens with a lens rim feature just described, further the semi-finished ophthalmic lens 201 includes multiple lens rim features.

In a second possible alternative to the semi-finished ophthalmic 201 lens with a lens rim feature 202described above, further at least one lens rim feature is custom designed in accordance with the requirements of a particular order.

In a third possible alternative to the semi-finished ophthalmic lens 201 with a lens rim feature 202 just described, further the lens rim features are substantially restricted to the periphery of the lens.

In a possible configuration of the third possible alternative just described, further “substantially restricted” means that the lens features 202 are manufactured onto the periphery of the semi-finished ophthalmic lens 201, and means further that any part of the lens rim features that extend beyond the periphery of the semi-finished ophthalmic lens 201 do not occupy more than 25% of the area of the semi-finished ophthalmic lens 201 that is not part of the periphery. In other embodiments, they do not occupy more than 15% or more than 5% of the area of semi-finished ophthalmic lens.

In a first possible variation of the possible configuration just described, further the lens rim features 202 do not substantially extend beyond the top part of the lens periphery.

In a second possible variation of the possible configuration just described above, further the lens rim 202 features do not substantially extend beyond the bottom part of the lens periphery.

In a fourth possible alternative to the semi-finished ophthalmic lens 201 with a lens rim feature just described, further the lens rim features 202 substantially occupy one half of the periphery of the lens.

In a possible configuration of the fourth possible alternative just described, further “substantially occupy one half” means that at least 90% of the area of that half of the periphery is occupied by the lens rim features 202. In other embodiments at least 80% or at least 70% of the area of the one half of the periphery is occupied by lens rim features, respectively.

In a first possible variation of the possible configuration just described, further the one half of the periphery that is occupied by lens rim features 202 is the upper half.

In a second possible variation of the possible configuration described above, further the one half of the periphery that is occupied by the lens rim features 202 is the bottom half.

In a fifth possible alternative to the semi-finished ophthalmic lens 201 with a lens rim feature just described, further the lens rim features 202 within the one half of the periphery form a cumulative angle of coverage in relation to the center of the lens when the lens is viewed from the front, that is as large or almost as large as the angle of coverage of the one half of the periphery, which is 180 degrees. In one embodiment, “almost as large as 180 degrees” is an angle of at least 140 degrees. In other embodiments, “almost as large as 180 degrees” is an angle of coverage of at least 150, at least 160, or at least 170 degrees, respectively.

One embodiment is a device for printing onto an ophthalmic lens 303, including an inkjet print-head 301 configured to print a lens rim feature onto an ophthalmic lens 303, in which the inkjet print-head 301 includes at least one nozzle 302, and in which the nozzle 302 is configured to eject a material onto the ophthalmic lens 303. Further, either the inkjet print-head 301 and/or the ophthalmic lens 303 are configured to move and rotate their relative positions such that the axis of each nozzle 302 and the ophthalmic lens 303 are approximately perpendicular the one to the other in the printing area during the ejection of material by any nozzle 302 onto the ophthalmic lens 303. Further, the device is configured to print one or more lens rim features onto the ophthalmic lens 303. In some embodiments, only the print-head 301 moves, in other embodiments only the lens 303 moves, and in yet other embodiments both the print-head 301 and the lens 303 move. In some embodiments there is a plurality of nozzles 302 configured to eject material onto the ophthalmic lens, 303 whereas in other embodiments there is a single nozzle.

In a first possible alternative to the device for printing onto an ophthalmic lens 303 just described, further the device for printing onto an ophthalmic lens 303 is configured to print multiple lens rim features.

In a second possible alternative to the device for printing onto an ophthalmic lens 303 described above, further at least one lens rim feature is custom designed in accordance with the requirements of a particular order.

In a third possible alternative to the device for printing onto an ophthalmic lens 303 described above, further the lens rim features are substantially restricted to the periphery of the lens.

In a possible configuration of the third possible alternative just described, further “substantially restricted” means that the lens rim features are manufactured onto the periphery of the lens, and means further that any part of the lens rim features that extend beyond the periphery of the lens do not occupy more than 25% of the area of lens. In other embodiments they do not occupy more than 15% or no more than 5% of the area of the lens, respectively.

In a first possible variation of the configuration just described, further the lens rim features do not extend substantially beyond the top part of the lens periphery.

In a second possible variation of the configuration described above, further the lens features do not extend substantially beyond the bottom part of the lens periphery.

In a fourth possible alternative to the device for printing onto an ophthalmic lens 303 described above, further the lens rim features substantially occupy one half of the periphery of the lens.

In a possible configuration of the fourth possible alternative just described, further “substantially occupy one half” means that at least 90% of the area of that half of the periphery is occupied by the lens rim features. In other embodiments, at least 80% or at least 70% of the area of the half of the periphery is occupied by the lens features, respectively.

In a first possible variation of the possible configuration just described, further the one half of the periphery that is occupied by lens rim features is the upper half.

In a second possible variation of the possible configuration described above, further the one half of the periphery that is occupied by the lens rim features is the bottom half.

In a fifth possible alternative to the device for printing onto an ophthalmic lens 303 described above, further the lens rim features within that one half of the periphery are configured such that the cumulative angle of coverage from the lens center when the lens is viewed form the front, is as large as or almost as large as the angle of coverage of the one half of the periphery, which is 180 degrees. In one embodiment, “almost as large as 180 degrees” is an angle of at least 140 degrees. In other embodiments, “almost as large as 180 degrees” is an angle of coverage of at least 150 degrees, at least 160 degrees, or at least 170 degrees, respectively. \

In a sixth possible alternative to the device for printing onto an ophthalmic lens 303 described above, further 3D inks and print heads are used to create lens rim features that are substantially thick. In some embodiments, “substantially thick” means thicker than 100 microns. In other embodiments “substantially thick” means thicker than 500 microns, or thicker than 1000 microns, or thicker than 3000 microns, respectively.

One embodiment is a system for printing a lens rim feature onto an ophthalmic lens 401, including an ophthalmic lens 401, and a device with a print-head 402 with one or more nozzles 405 configured to create one or more lens rim features by ejecting material onto the ophthalmic lens 401. Further, the system includes a computer (not shown) fitted with software capable of calculating at each instance the optimal position and orientation of the print head 402 in relation to the ophthalmic lens 401, and capable of converting a graphical file that is to be printed into machine instructions that are communicated to the device with print head 402. Further, the system includes a device 403 for grasping the ophthalmic lens 401, and a device 404 for moving and rotating either the ophthalmic lens 401or the device with print-head 403, or both the lens 401 and the device with print-head 402. Further, the moving and rotating device 404 is configured to perform such movement and rotation such that the ophthalmic lens 401 and the axis of each nozzle 405 of device with print-head 402 are approximately perpendicular the one to the other in the printing area during the ejection of material from the print-head 402 onto the ophthalmic lens 401. (In some embodiments, there is a single nozzle 405, whereas in alternative embodiments there are multiple nozzles 405.)

In a first possible alternative to the system for printing a lens rim feature onto an ophthalmic lens 401 just described, further includes multiple lens rim features on the ophthalmic lens 401.

In a second possible alternative to the system for printing a lens rim feature onto an ophthalmic lens 401 described above, further at least one lens rim feature is custom designed in accordance with the requirements of a particular order.

In a third possible alternative to the system for printing a lens rim feature onto an ophthalmic lens 401 described above, further the lens rim features are substantially restricted to the periphery of the lens.

In a possible configuration of the third possible alternative just described, further “substantially restricted” means that the lens rim features are manufactured onto the periphery of the lens, and means further that any part of the lens rim features that extend beyond the periphery of the lens do not occupy more than 25% of the area of the lens that is not part of the periphery. In other embodiments, they do not occupy more than 15%, or no more than 5%, of the area of lens, respectively.

In a first possible variation of the first possible configuration just described, further the lens rim features do not extend substantially beyond the top part of the lens periphery.

In a second possible variation of the first possible configuration described above, further the lens rim features do not extend substantially beyond the bottom part of the lens periphery.

In a fourth possible alternative to the system for printing a lens rim feature onto an ophthalmic lens 401 described above, further the lens rim features substantially occupy one half of the periphery of the lens.

In a possible configuration of the fourth possible alternative just described, further “substantially occupy one half” means that at least 90% of the area of that one half of the periphery area is occupied by the lens rim features. In other embodiments at least 80%, or at least 70%, of the area of the one half of the periphery, respectively, is occupied by the lens features.

In a first possible variation of the possible configuration just described, further the one half of the periphery that is occupied by lens rim features is the upper half.

In a second possible variation of the possible configuration described above, further the one half of the periphery that is occupied by the lens rim features is the bottom half.

In a fifth possible alternative to the system for printing a lens feature onto an ophthalmic lens 401 described above, further the lens rim features within that one half of the periphery are configured such that the cumulative angle of coverage from the lens center when the lens is viewed from the front, is as large as or almost as large as the angle of coverage of the one half of the periphery, which is 180 degrees. In one embodiment, “almost as large as 180 degrees” is an angle of at least 140 degrees. In other embodiments, “almost as large as 180 degrees” is an angle of coverage of at least 150 degrees, or at least 160 degrees, or at least 170 degrees, respectively.

Various methods for manufacturing one or more lens rim features are contemplated within the scope of the invention. Several exemplary embodiments are described below, but these exemplary embodiments are not exhaustive, and the scope of the invention includes any means by which one or more lens features may be manufactured. It is understood that in some embodiments the lens is manufactured first, after which the lens rim features are added to the already produced lens rim. It is understood that in some embodiments, the lens itself and the lens rim features are manufactured together, such that the lens and its rim features come into existence essentially at the same time.

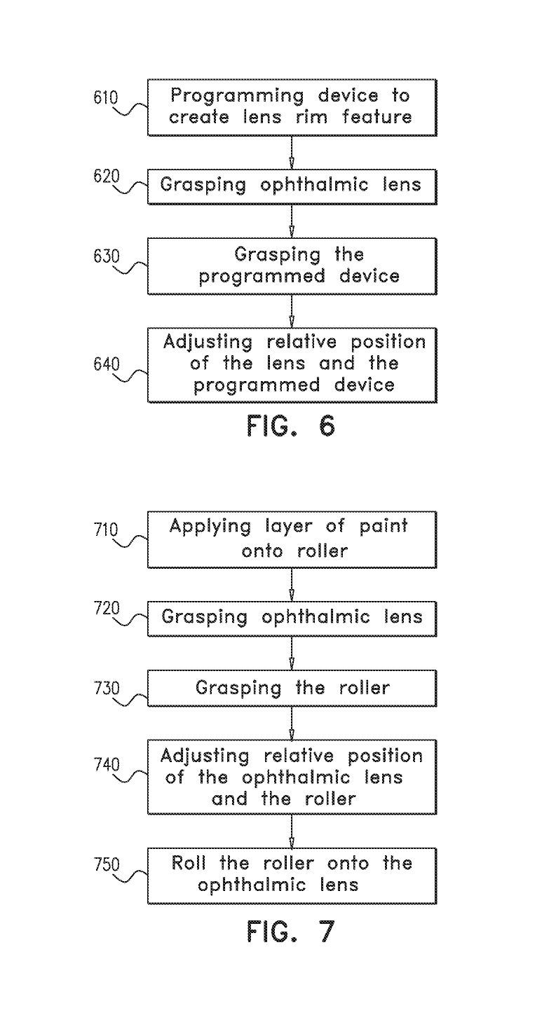

FIG. 6 illustrates one embodiment of a method for manufacturing one or more lens rim features onto an ophthalmic lens, using a device with at least one nozzle. In step 610, a system programs a device with print-head having at least one nozzle to create a lens rim feature by ejecting material from the any of its nozzles onto an appropriate surface of an ophthalmic lens. The programming may be done by a computer or by any other element capable of sending digital instructions to the device with print-head and at least one nozzle. In step 620, a grasping device grasps the ophthalmic lens. In step 630, a grasping device, which may be the same grasping device as in step 620 or a different grasping device, grasps the programmed device with print-head and at least one nozzle. Further, the order of the steps may be such that the programmed device with print-head is grasped before the lens is grasped. Alternatively, the device with print-head and the lens may be grasped at substantially the same time. In step 640, the programming device sends instructions to the grasping device (or one of two grasping devices, or both of two grasping devices), on how to adjust the relative position and orientation of the ophthalmic lens and/or the relative position and orientation of the programmed device with print-head and at least one nozzle, such that the ophthalmic lens and the axes of the all the nozzles on the programmed device with print-head are approximately perpendicular the one to the other in the printed area during the ejection of material from any of the nozzles of the device with print-head onto the appropriate surface of the ophthalmic lens. The process may be repeated for any other lens surfaces for which lens rim features of this type are desired.

In an alternative embodiment to the method for manufacturing an ophthalmic lens with a lens rim feature, just described, further the information for programming the device with print-head and nozzles is derived from the requirements of a custom design of the lens rim feature. This custom design may be selected by a customer, which may come either from an inventory of available features or by a feature imagined by the customer. Alternatively, various lenses may be manufactured with various lens rim features, according to spec and not according to customer design, and such lenses may they be selected by customers.

In a first possible configuration of the alternative embodiment just described, further the grasping of the ophthalmic lens and the grasping of the programmed device with print-head are performed by a single grasping mechanism.

In a second possible configuration of the alternative embodiment just described, further the grasping of the ophthalmic lens and the grasping of the programmed device with print-head with nozzle are performed by two separate grasping mechanisms.

In a third possible configuration of the alternative embodiment just described, further the grasped position of the programmed device with print-head is temporary. After the particular lens has been completed, or upon completion of one stage of the manufacture of a lens, the device grasping the programmed device with print-head may release such programmed device with print-head.

FIG. 7 illustrates one embodiment of a method for manufacturing one or more lens rim features onto an ophthalmic lens, by applying one or more layers of paint. In step 710, a layer of paint is applied to a roller or rolling device, wherein such paint is capable of adhering to a lens surface. In step 720, an ophthalmic lens is grasped by a grasping device. In step 730, the roller or rolling device is grasped by a grasping device. In some embodiments, a single grasping device grasps both the ophthalmic lens and the roller or rolling device. In other embodiments, there are two separate grasping devices, one for the ophthalmic lens and the other for the roller or rolling device. In step 740, the grasping device(s) move or rotate either the lens or the roller or both, such that the roller will be in contact with the lens at predesignated locations on the lens surface. In step 750, the grasping device(s) move either or both of the lens and the roller to create a rolling effect on the lens that applies the paint to the predesignated locations on the lens surface. In one embodiment, the lens is held stationary while the roller is rolled. In an alternative embodiment, the roller is held stationary while the lens is moved to create a rolling effect that applies paint to the predesignated locations on the appropriate lens surface. In another alternative embodiment, both the lens and the roller are moved to create a rolling effect that applies paint to the predesignated locations on the lens surface. In some embodiments, only one roll or rolling effect is implemented, where, for example, the lens rim features have only one color, or where, for example, there are multiple colors but these multiple colors have been applied to different locations on the roller such that only one roll or rolling effect is required to apply the colors to the lens. In other embodiments, there are multiple rolls or rolling effects, in which each such roll or rolling effect applies a different color, or paints different locations on the lens rim surface. The process may be repeated for any other lens surfaces for which lens rim features of this type are desired. In alternative embodiments, the grasping may be done by human hands.

The roller may be complex. For example, it may have slits running along its length—creating striped patterns on the lens' surfaces as it rolls over them. As another example, the roller's profile may be round, so that a wider band of the roller's surface will come into contact with the lens' surface as more pressure is applied upon it. As another example, the roller's profile may by square so that the same width of roller surface is in contact with the lens' face regardless of the pressure that is applied upon it. As another example, the roller's surface may be porous, thus creating a pattern on the lens' surface of uneven texture. Furthermore, the roller may have pores of varying sizes at different areas of its profile, creating a texture of varying unevenness. The location of the center of the roller relative to the lens' front edge or back edge contour may change as the lens is rotated.

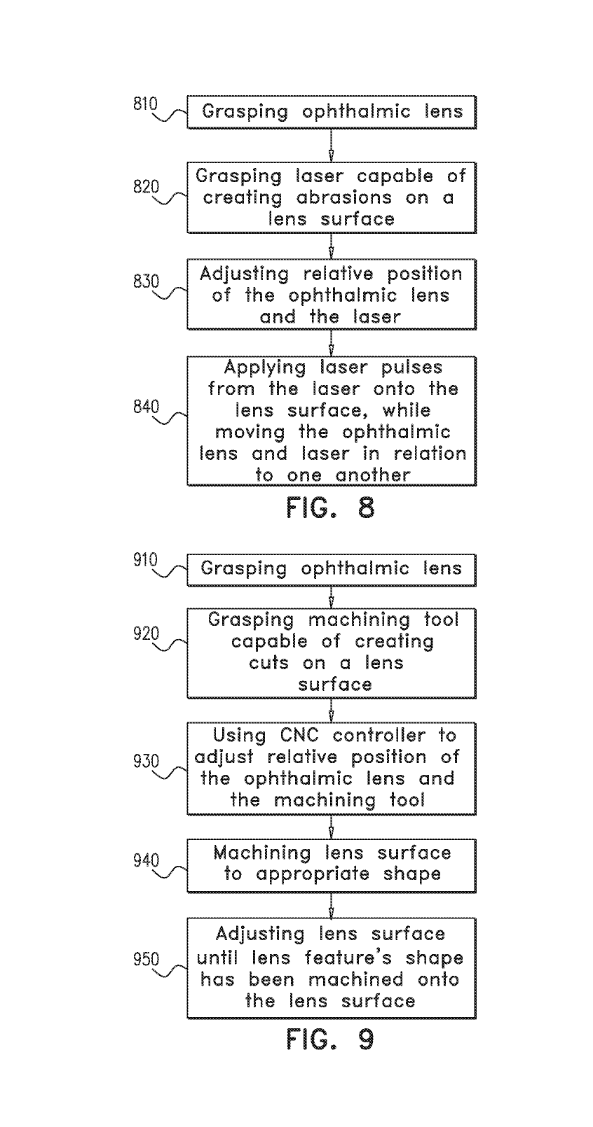

FIG. 8 illustrates one embodiment of a method for manufacturing one or more lens rim features onto an ophthalmic lens, by use of a laser. In step 810, an ophthalmic lens is grasped by a grasping device. In step 820, a laser capable of creating abrasions on a lens surface is grasped by a grasping device. In some embodiments, a single grasping device grasps both the ophthalmic lens and the laser. In other embodiments, there are two separate grasping devices, one for the ophthalmic lens and the other for the laser. In step 830, the grasping device(s) move or rotate either the lens or the laser or both, such that the laser beam will be directed at a predesignated location on the lens surface. In step 840, the grasping device(s) move either or both of the lens and the laser, while the laser applies laser pulses from the laser onto the lens surface. In one embodiment, the lens is held stationary while the laser is moved, while the laser applies laser pulses. In an alternative embodiment, the laser is held stationary while the lens is moved, while the laser applies laser pulses. In another alternative embodiment, both the lens and the laser are moved, while the laser applies laser pulses. The moving of either or both of the lens and the laser continues while applying laser pulses to predesignated areas on the lens surface, until the lens rim features have been created on the appropriate surface of the lens.

In one further embodiment, an optical system is placed between the lens and the laser, and the optical system redirects the laser beam onto different locations on the lens by changing the location and/or tilts of the lenses and/or mirrors that compose the optical system one in relation to the other, while the laser and the ophthalmic lens may remain stationary. In another embodiment, an optical system of the same type is used, but here the laser and/or ophthalmic lens may also move and rotate in synchronized fashion with regards to the movements of the lenses and/or mirrors in the optical system. This process may be repeated for any other surface on the lens on which laser abrasion lens rim features are desired.

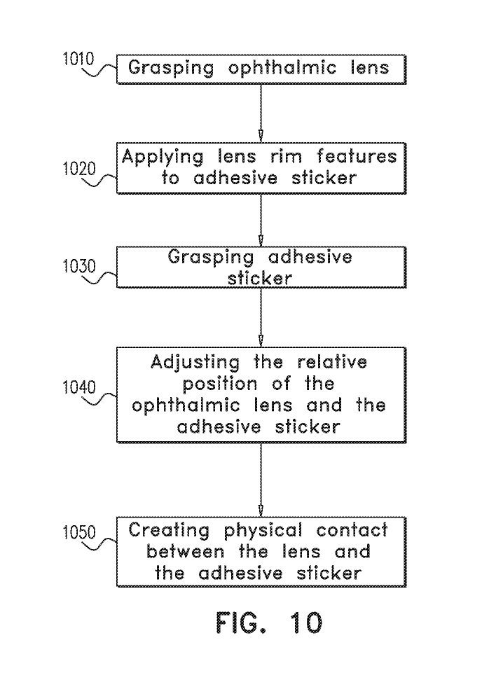

FIG. 9 illustrates one embodiment of a method for manufacturing one or more lens rim features onto an ophthalmic lens, by use of a machining tool. The machining tool may be a milling tool, a grinding tool, a drilling tool, or a stationary tool used in machine turning applications. In step 910, an ophthalmic lens is grasped by a grasping device. In step 920, a machining tool capable of creating cuts in a lens surface is grasped by a grasping device. In some embodiments, a single grasping device grasps both the ophthalmic lens and the machining tool. In other embodiments, there are two separate grasping devices, one for the ophthalmic lens and the other for the machining tool. In step 930, the grasping device(s) move or rotate either the lens or the milling tool or both, such that the point of milling tool will be directed at a predesignated location on the lens surface. In step 940, the grasping device(s) move either or both of the lens and the machining tool, while the machining tool machines the surface of the lens to a shape and design appropriate for a lens rim feature. In one embodiment, the lens is held stationary while the machining tool is moved and the machining tool creates cuts in the lens. In an alternative embodiment, the machining tool is held stationary while the lens is moved, while the machining tool creates cuts in the lens. In another alternative embodiment, both the lens and the machining tool are moved, while the machining tool creates cuts in the lens. In step 950, the moving of either or both of the lens and the machining tool continues while the machining tool creates cuts in the lens at predesignated areas on the lens surface, until the lens rim features have been created on the appropriate surface of the lens. This process may be repeated for any other surface on the lens on which machined lens rim features are desired.

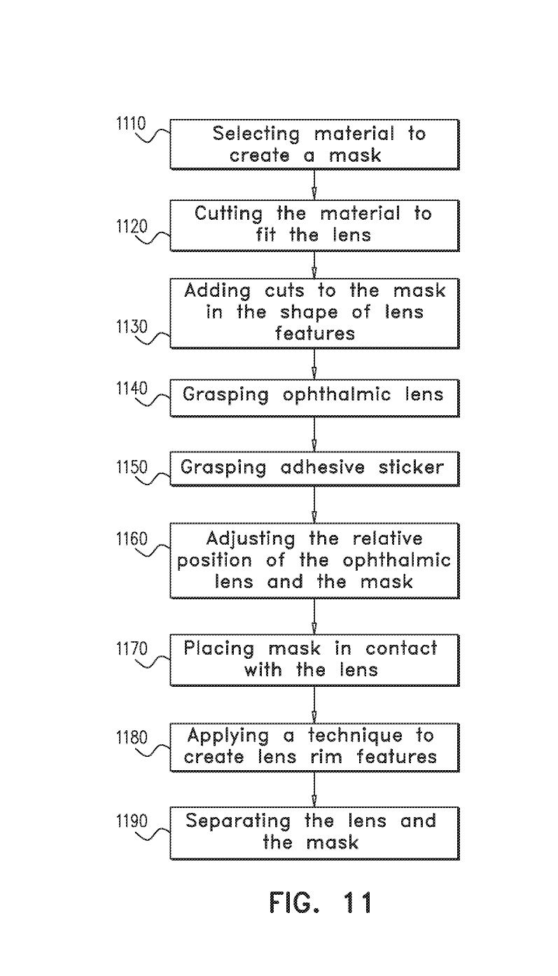

FIG. 10 illustrates one embodiment of a method for manufacturing one or more lens rim features onto an ophthalmic lens, by use of an adhesive sticker. In step 1010, an ophthalmic lens is grasped by a grasping device. In step 1020, one or more lens rims features are applied onto an adhesive sticker. In step 1030, the adhesive sticker is a grasped by a grasping device. In some embodiments, a single grasping device grasps both the ophthalmic lens and the adhesive sticker. In other embodiments, there are two separate grasping devices, one for the ophthalmic lens and the other for the adhesive sticker. In step 1040, the grasping device(s) move or rotate either the lens or the adhesive sticker or both, such that the adhesive sticker will be directed at a predesignated location on the appropriate lens surface. In step 1050, the grasping device(s) move either or both of the lens and the adhesive sticker such that the lens and the adhesive sticker are in physical contact, and the lens rim feature(s) that had been applied to the adhesive sticker are transferred to the lens surface. In one embodiment, the lens is held stationary while the adhesive sticker is moved, and the lens rim feature(s) are transferred. In an alternative embodiment, the adhesive sticker is held stationary while the lens is moved, and the lens and adhesive sticker are brought in to contact with an appropriate orientation on the appropriate lens surface. In another alternative embodiment, both the lens and the adhesive sticker are moved, and adhesive sticker are brought in to contact with an appropriate orientation on the appropriate lens surface. If additional transfers of lens rim features are required, then the process is repeated until all of the lens rim features have been transferred from the adhesive sticker and adhered to the lens rim surface. In some embodiments, the sticker along with the lens rim features that have been applied to it remain permanently adhered to the appropriate lens surface. The process may be repeated for any other lens surfaces for which lens rim features of this type are desired. In alternative embodiments, the grasping may be done by human hands.

FIG. 11 illustrates one embodiment of a method for manufacturing one or more lens rim features onto an ophthalmic lens, by using one or more specific techniques. In step 1110, a material is selected from which to create a mask. In some embodiments, this is a thin and relatively flexible material that can be easily manipulated to mimic the shape of an ophthalmic lens. In step 1120, the material is cut to the shape of the lens' edge. In step 1130, cuts are applied in the material at predesignated locations on the mask and in the shape of the lens features that are desired. In step 1140, the ophthalmic lens is grasped by a grasping device. In step 1150, the mask is grasped by a grasping device. In some embodiments, a single grasping device grasps both the ophthalmic lens and the mask. In other embodiments, there are two separate grasping devices, one for the ophthalmic lens and the other for the mask. In step 1160, the grasping device(s) move or rotate either the lens or the mask or both, such that the cuts in the mask will be directly aligned above one or more predesignated locations on the appropriate lens surface. In step 1170, the mask is placed in physical contact with the lens. In step 1180, a specific technique is used to create the lens rim features on surface of the lens. In step 1190, the mask and the lens are physically separated. The process may be repeated for any other lens surfaces for which lens rim features of this type are desired. In alternative embodiments, the grasping may be done by human hands.

In one alternative embodiment to the manufacturing method just described, the specific technique used is that a layer of paint is applied onto the appropriate lens surface and the mask, such that the paint in contact with the mask does not transfer to the appropriate lens surface, and the paint at the cuts in the mask transfers to the lens and adheres to the lens. In another alternative embodiment to the manufacturing method just described, the specific technique used is that sand blasting is applied onto the appropriate lens surface and the mask, such that the blasting creates the rim features on the appropriate surface of the lens. In another alternative embodiment to the manufacturing method just described, the specific technique is that a chemical abrasive to the lens substrate but not to the mask is applied on the lens and mask on the appropriate lens surface, thus creating chemical abrasions at the cuts on the appropriate lens surface. These constitute lens rim features on the appropriate surface of the lens. The process may be repeated for any other lens surfaces for which lens rim features of this type are desired. The alternative embodiments presented here are exemplary only, and not exhaustive. It is understood that the invention contemplates and includes all manufacturing methods that may be used to create lens rim features onto the surface of an ophthalmic lens. Further, in various alternative embodiments, the manufacturing method includes two or more specific techniques. With any of the specific techniques or any combination of specific techniques, in alternative embodiments the grasping is done by human hands.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagram illustrates non-limiting embodiment/case example of the methods, and block diagrams illustrate non-limiting embodiment/case examples of the devices. Some operations in the flow diagram may be described with reference to the embodiments/cases illustrated by the block diagrams. However, the method of the flow diagram could be performed by embodiments/cases of the invention other than those discussed with reference to the block diagrams, and embodiments/cases discussed with reference to the block diagrams could perform operations different from those discussed with reference to the flow diagram. Moreover, although the flow diagram may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, a system may include multiple compute elements, each of which is communicatively connected to multiple servers, even though specific illustrations presented herein include only one compute element or a maximum of two compute elements.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. An ophthalmic lens with a lens rim feature, comprising:
an ophthalmic lens with corrective optics; and
one or more lens rim features;
in which said ophthalmic lens rim features are an integral part of the ophthalmic lens.

2. The ophthalmic lens of claim 1, comprising a plurality of lens rim features.

3. The ophthalmic lens of claim 1, in which at least one lens rim feature is custom designed in accordance with requirements of a particular order.

4. The ophthalmic lens of claim 1, wherein the lens rim features are substantially restricted to the periphery of the lens.

5. The ophthalmic lens of claim 1, wherein the lens rim features substantially occupy one half of the periphery of the lens.

6. The ophthalmic lens of claim 1, wherein the lens rim features within one half of the periphery form a cumulative angle of coverage in relation to the center of the lens which is substantially as large or almost as large as the angle of coverage of one half of the periphery.

7. The ophthalmic lens of claim 1, wherein at least one lens rim feature is substantially thin.

8. The ophthalmic lens of claim 1, wherein at least one lens feature is cumulative weight of all the lens rim features is substantially small.

9. A device for printing onto an ophthalmic lens, comprising:
an inkjet print-head configured to print a lens rim feature onto an appropriate surface of an ophthalmic lens;
wherein said inkjet includes at least one nozzle;
wherein said nozzle is configured to eject a material onto an ophthalmic lens;
wherein said device and said ophthalmic lens are configured to move and rotate their relative positions such that the axis of any of said nozzles and said ophthalmic lens are approximately perpendicular the one to the other in the printing area during the ejection of material by the nozzles onto the ophthalmic lens; and
wherein device with print-head is configured to print one or more lens rim features onto the lens.

10. The device for printing onto an ophthalmic lens of claim 9 is further configured to print a plurality of lens rim features.

11. The device for printing onto an ophthalmic lens of claim 9, in which at least one lens rim feature is custom designed in accordance with the requirements of a particular order.

12. The device for printing onto an ophthalmic lens of claim 9, wherein the lens rim features are substantially restricted to the periphery of the lens.

13. The device for printing onto ophthalmic lens of claim 9, wherein lens rim features substantially occupy one half of the periphery of the lens.

14. The device for printing onto ophthalmic lens of claim 9, wherein the lens rim features within one half of the periphery form a cumulative angle of coverage in relation to the center of the lens which is substantially as large or almost as large as the angle of coverage of one half of the periphery.

15. A system for printing a lens rim feature onto an ophthalmic lens, comprising:
an ophthalmic lens;
a device with a print-head with a nozzle configured to create one or more lens rim features by ejecting material onto said appropriate surface of ophthalmic lens;
a computer fitted with software capable of calculating at each instance the optimal position and orientation of said print head in relation to said appropriate surface of ophthalmic lens, and capable of converting a graphical file that is to be printed into machine instruction that are communicated to said device with print head
a device for grasping said ophthalmic lens;
a device for moving and rotating either said ophthalmic lens, or said device with print-head, or both said ophthalmic lens and said device with print-head;
wherein said moving and rotating device is configured to perform such rotation such that said ophthalmic lens and the axis of all nozzles of device with print-head, are approximately perpendicular the one to the other in the printing area during the ejection of material from said print-head onto said appropriate surface of ophthalmic lens.

16. The system for printing of claim 15, further configured to print a plurality of lens rim features.

17. The system for printing of claim 15, in which at least one lens rim feature is custom designed in accordance with the requirements of a particular order.

18. The system for printing of claim 15, wherein the lens rim features are substantially restricted to the periphery of the lens.

19. The system for printing of claim 15, wherein the lens rim features substantially occupy one half of the periphery of the lens.

20. The system for printing of claim 15, wherein the lens rim features within one half of the periphery form a cumulative angle of coverage in relation to the center of the lens which is as large as or substantially almost as large as the angle of coverage of one half of the periphery.

21. A method for manufacturing an ophthalmic lens with a lens rim feature, comprising:
applying onto a roller a layer of paint capable of adhering to a lens surface;
grasping an ophthalmic lens;
grasping the roller onto which a layer of paint has been applied;
moving and rotating the ophthalmic lens and the roller one in relation to the other in such a fashion that the roller is in contact with the appropriate lens surface at predesignated locations on the lens surface; and
moving the roller or the ophthalmic lens so as to create an effect of the roller rolling onto the ophthalmic lens, such that one or more lens rim features are created on the appropriate surface of the lens.
